(19) United States
(12) Patent Application Publication
(10) Pub. No.: US 2025/0101620 A1
(43) Pub. Date: Mar. 27, 2025

(54) SOLAR-BASED CRYOGENIC AIR SEPARATION AND WATER ELECTROLYZER FOR GREEN AMMONIA PRODUCTION WITH CO-PRODUCTION OF OXYGEN

(71) Applicants: KING FAHD UNIVERSITY OF PETROLEUM AND MINERALS, Dhahran (SA); King Abdullah City for Atomic & Renewable Energy (K.A.CARE), Riyadh (SA)

(72) Inventors: Esmail Mohamed Ali MOKHEIMER, Dhahran (SA); Binash IMTEYAZ, Dhahran (SA); Fahad Abdulaziz ALSULAIMAN, Dhahran (SA)

(73) Assignees: KING FAHD UNIVERSITY OF PETROLEUM AND MINERALS, Dhahran (SA); King Abdullah City for Atomic & Renewable Energy (K.A.CARE), Riyadh (SA)

(21) Appl. No.: 18/472,886

(22) Filed: Sep. 22, 2023

(51) Int. Cl. C25B 15/08; B01J 21/04; B01J 23/58; B01J 35/04; C01C 1/04; C25B 1/04; C25B 9/19

(52) U.S. Cl. CPC C25B 15/081; B01J 21/04; B01J 23/58; B01J 35/56; C01C 1/0411; C01C 1/0417; C25B 1/04; C25B 9/19

(57) ABSTRACT

A solar-powered ammonia and oxygen production system is disclosed. The system includes an electrolyzer, a PV cell unit, an absorption cooling unit (ACU), a solar parabolic trough collector (PTC), a cryogenic air separation unit (CSU), a cooler, an air compressor, a hydrogen compressor and a nitrogen compressor, an air turbine, and a catalytic converter. The system utilizes these components to co-produce ammonia and oxygen while generating surplus power. The PTC is thermally coupled with the ACU to cool the air coming from the air compressor. The cold air is supplied to the CSU. The nitrogen output from the CSU feeds into the nitrogen compressor, and from there, to the catalytic converter. The hydrogen from the electrolyzer is compressed by the hydrogen compressor, and supplied to the catalytic converter. The catalytic converter further produces ammonia based on the hydrogen and nitrogen received therein.

### BACKGROUND

### Technical Field

The present disclosure relates to the field of renewable energy production and storage. More specifically, the present disclosure pertains to a system that utilizes solar energy to efficiently produce ammonia and co-produce oxygen.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The modern world faces an urgent need to address energy security and environmental crises, which have escalated to unprecedented levels of global concern. The long-term solution to these challenges lies in transitioning towards renewable energy sources and ensuring a clean energy supply for sustainable technological development. Despite numerous efforts, the rate of growth for renewable energy has not been substantial, primarily due to various challenges associated with its implementation. Major obstacles include the need for efficient energy conversion, storage, and long-distance transportation, all of which require further innovation and technological advancement.

Hydrogen energy has been identified as a potential future energy carrier due to its clean nature and the ease with which it can be produced from renewable sources. However, the transportation and storage of hydrogen present significant challenges due to associated hazards and cost inefficiencies. These issues have resulted in need for innovative solutions, particularly in terms of energy carriers that can facilitate the practical utilization of hydrogen energy. One such solution involves converting hydrogen gas into hydrogen-rich compounds that can be liquefied under mild conditions.

Compounds such as ammonia, methane, and methanol have been explored for this purpose. Ammonia, being carbon-free, is a great alternative and is deemed a potential hydrogen energy carrier of the future. Ammonia possesses an energy density of 13.6 GJ/m³ and is characterized by features like liquefaction at room temperature, high volumetric and gravimetric density, and low risk hazards during storage, transportation, and utilization. Furthermore, hydrogen may be easily and efficiently converted to ammonia through well-established processes such as the Haber-Bosch process.

Moreover, various hydrogen production technologies that use renewable energy sources have attained technological and industrial maturity. These include photochemical, thermochemical, and electrochemical techniques. However, hydrogen production is highly energy-intensive, whether achieved through hydrocarbon reforming or water splitting. This necessitates the provision of an energy-efficient design with proper heat recuperation and co-production cycles to effectively reduce the production cost of hydrogen.

Also, generally, there is a significant demand for oxygen for various applications. For instance, oxygen is a critical component in many industrial applications and is also essential for medical purposes. Conventional methods of oxygen production, such as, pressure swing adsorption, is energy-intensive and often require large-scale infrastructure, making them less suitable for remote or resource-limited settings. A new technique based on cryogenic air separation has opened new possibilities for efficient oxygen production. Cryogenic air separation unit (CSU) have demonstrated the ability to separate oxygen from air with high purity while requiring minimal energy. This technology works on the principle of cooling and compressing the air at very low temperatures and high pressures and then furthering the process with expansion thereby separating a plurality of components present in the air.

However, the operational characteristics of CSUs present their own set of challenges. Notably, CSUs typically operate at extremely low temperatures and high pressures, which can lead to a significant amount of heat being rejected during operation. This waste heat, if not effectively utilized, contributes to the overall energy inefficiency of the process. Further, the integration of CSUs within a renewable energy system introduces additional complexities. For instance, the intermittent nature of many renewable energy sources, such as solar and wind, complicates the continuous operation of the CSU.

Furthermore, the use of solar energy for powering above-described systems in current form, including hydrogen production system, hydrogen conversion system, or CSU based system, is also limited by efficiency issues. Photovoltaic (PV) panels, for instance, have their efficiency compromised by heat, which reduces the power output. Cooling techniques are needed to enhance the efficiency of these panels, but these techniques themselves often require additional energy input, and carried heat from the PV panels is often wasted, thereby offsetting the benefits.

Thus, it may be noted that while significant advances have independently been made in each of the areas of harnessing renewable energy sources, hydrogen production and conversion, oxygen production, particularly via CSUs, these systems have mostly been developed in silos. There has been no attempt made to integrate these systems and exploit possible synergies.

Accordingly, it is one object of the present disclosure to provide an integrated system capable of efficiently producing green ammonia and oxygen using renewable energy sources, and specifically, using solar power for both thermal and electrical energy needs. Such integrated system may also need to improve the efficiency of solar PV panels. Moreover, it may be advantageous for such integrated system to have the ability to produce surplus power, making it a beneficial and practical solution for renewable energy production and storage.

### SUMMARY

In an exemplary embodiment, a solar-powered ammonia and oxygen production system is provided. The solar-powered ammonia and oxygen production system includes an electrolyzer having a water inlet, an oxygen outlet and a hydrogen outlet. The solar-powered ammonia and oxygen production system further includes a PV (Photovoltaic) cell unit including a PV panel, a thermoelectric generator panel, and a plurality of water channels. The PV cell unit is electrically connected to the electrolyzer. The solar-powered ammonia and oxygen production system further includes an absorption cooling unit (ACU) including a solar parabolic trough collector (PTC), a cooler thermally connected to the ACU, and a cryogenic air separation unit (CSU) having a compressed air inlet, an oxygen outlet, and a nitrogen outlet. The solar-powered ammonia and oxygen production system further includes a nitrogen compressor fluidly connected to the nitrogen outlet of the CSU, and a catalytic converter having a hydrogen inlet, a nitrogen inlet and an ammonia outlet. The hydrogen inlet of the catalytic converter is fluidly connected to the hydrogen outlet of the electrolyzer, and the nitrogen inlet of the catalytic converter is fluidly connected to the nitrogen outlet of the CSU. The hydrogen outlet of the electrolyzer is fluidly connected to a hydrogen compressor fluidly connected to the hydrogen inlet of the catalytic converter. Moreover, the solar-powered ammonia and oxygen production system further includes a motor connected to an air compressor and an air turbine, wherein the motor is electrically connected to the PV cell unit and the air compressor has an air outlet fluidly connected to the air turbine upstream of the cooler.

In some embodiments, the electrolyzer includes a solid polymer to catalyze dissociation of water to oxygen and hydrogen.

In some embodiments, the PTC is configured to provide thermal energy for the ACU and the cooler.

In some embodiments, the catalytic converter is configured to catalyze reaction of hydrogen and nitrogen to form ammonia at a pressure ranging from 200 bar to 500 bar.

In some embodiments, the catalytic converter includes a ruthenium-calcium-aluminum metal catalyst dispersed in hexagonal vacancies of a synthetic cordierite ceramic support.

In some embodiments, each water channel of the plurality of water channels runs longitudinally along a long axis of the PV panel, wherein an upstream end of the water channels includes an inlet header, and a downstream end of the water channels includes an outlet header.

In some embodiments, the outlet header of the plurality of water channels is in fluid communication with the water inlet of the electrolyzer.

In some embodiments, at least 90% of an area of a back surface of the PV cell unit is in thermal communication with the water channels of the plurality of water channels.

In some embodiments, at least 90% of a back surface of the PV panel is in direct thermal communication with the thermoelectric generator panel.

In some embodiments, at least 90% of a back surface of the thermoelectric generator panel is in direct fluid communication with the water channels of the plurality of water channels.

In some embodiments, the PV cell unit is directly adjacent to the electrolyzer and the outlet header of the plurality of water channels is integral with the water inlet of the electrolyzer.

In some embodiments, the solar-powered ammonia and oxygen production system further includes a turbine/throttle in fluid communication with the ammonia outlet of the catalytic converter.

In some embodiments, a low-pressure (around 10 bar) ammonia outlet of the ammonia compressor has an outlet in fluid communication with an ammonia storage tank.

In some embodiments, a hydrogen inlet of the hydrogen compressor is in fluid communication with the hydrogen outlet of the electrolyzer and a hydrogen outlet of the hydrogen compressor is in fluid communication with the hydrogen inlet of the catalytic converter.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a solar-powered ammonia and oxygen production system, according to certain embodiments;

FIG. 2 is a schematic diagram of a solar-powered ammonia and oxygen production system, based on the solar-powered ammonia and oxygen production system of FIG. 1, with additional components such as throttle valve, according to certain embodiments;

FIG. 3 is a schematic planar cross-section view of a PV cell unit for the solar-powered ammonia and oxygen production system of FIG. 1, according to certain embodiments;

FIG. 4 is a schematic exploded perspective view of the PV cell unit, according to certain embodiments;

FIG. 5 is a schematic diagram of a solar-powered ammonia and oxygen production system, based on the solar-powered ammonia and oxygen production system of FIG. 1, with a thermoelectric generator panel of the PV cell unit integrated with an electrolyzer therein, according to certain embodiments; and

FIG. 6 is a schematic diagram of a solar-powered ammonia and oxygen production system, based on the solar-powered ammonia and oxygen production system of FIG. 1, with additional components attached to improve efficiency of the system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a solar-powered ammonia and oxygen production system (“system”) designed for co-production of ammonia and oxygen. Leveraging renewable energy sources, specifically solar power, the system incorporates various components and processes to achieve efficient energy utilization and production. Specifically, the system involves the electrolysis of water to produce hydrogen and oxygen. Further, an air separation process separates nitrogen from air. This nitrogen then reacts with the produced hydrogen in a catalytic converter to form ammonia. The system effectively manages the thermal and electrical energy requirements using solar power. The system's operation is marked by a high degree of efficiency, achieved through the reuse of heat from various processes and using thermo-electric generation for active cooling and additional power generation. The system is characterized by its carbon-free operation and its use of abundant and readily available raw materials, namely air and water. The result is a renewable energy system capable of co-producing ammonia and oxygen with the added capability of generating surplus power.

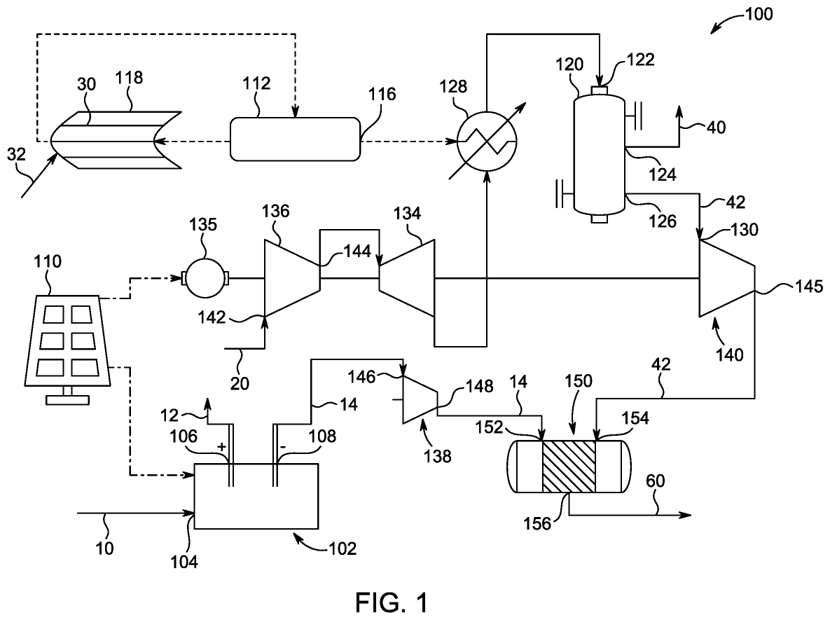

Referring to FIG. 1, illustrated is a solar-powered ammonia and oxygen production system 100 (hereinafter referred to as “the system 100”), according to an embodiment of the present disclosure. The system 100 includes several components, each serving a unique function that contributes to the overall operation thereof. In particular, the system 100 is an integration of various components, each performing a unique function to achieve the overall objective of co-producing ammonia and oxygen using solar power, and surplus power generation. The system 100 provides an environment-friendly technology solution to address various challenges in the fields of renewable energy and chemical production.

As illustrated in FIG. 1, the system 100 includes an electrolyzer 102 having a water inlet 104, an oxygen outlet 106, and a hydrogen outlet 108. The electrolyzer 102 is configured to catalyze dissociation of water into oxygen and hydrogen. For this purpose, water (as represented by reference numeral 10) is introduced into the electrolyzer 102 through the water inlet 104. The electrolyzer 102 applies an electric current to the water 10, causing it to separate into constituent oxygen (as represented by reference numeral 12) and hydrogen (as represented by reference numeral 14), via a process known as electrolysis. That is, as a result of the electrolysis process, the oxygen 12 and the hydrogen 14 are produced. In particular, the electrolyzer 102 typically consists of an anode and a cathode separated by an electrolyte. When the electric current is applied, the water 10 at the anode is oxidized to produce the oxygen 12 and positively charged hydrogen ions (protons). These protons then migrate through the electrolyte to the cathode, where they are reduced to form the hydrogen 14. In this way, the electrolyzer 102 produces both the oxygen 12 and the hydrogen 14 from the water 10. In the system 100, the oxygen 12 is expelled from the electrolyzer 102 through the oxygen outlet 106 (to be stored in an oxygen tank or the like), while the hydrogen 14 is expelled through the hydrogen outlet 108 for further use in the system 100, as discussed later in the description.

In an exemplary embodiment, the electrolyzer 102 in the system 100 includes a solid polymer (i.e., a solid polymer-based electrolyte) to catalyze the dissociation of the water 10 into the oxygen 12 and the hydrogen 14. This type of electrolyzer is often referred to as a Polymer Electrolyte Membrane (PEM) electrolyzer (also known as Proton Exchange Membrane electrolyzer). In the PEM electrolyzer, the electrolyte is a solid specialty thermoplastic material. This polymer is permeable to protons when it is saturated with the water 10, but it does not conduct electrons. The core component of the PEM electrolyzer is the membrane electrode assembly (MEA), which includes the polymer electrolyte membrane plus the anode and cathode. The electrolysis process begins when the water 10, supplied to the anode side, is oxidized to produce the oxygen 12, protons (H+ ions), and electrons. The generated protons then migrate through the polymer electrolyte membrane to the cathode side. Simultaneously, the electrons travel through an external circuit, creating the electrical current that powers the electrolyzer. When the protons reach the cathode, they combine with electrons from the external circuit to form the hydrogen 14. The electrolyzer 102 utilizing solid polymer have several advantages. Such electrolyzer 102 may be able to operate at high current densities, which means it can produce a large volume of the hydrogen 14 within a compact system footprint. The electrolyzer 102 is also capable of rapidly starting and stopping, which makes it well-suited to operate with intermittent power supplies, as required in the system 100.

The system 100 also includes a photovoltaic (PV) cell unit 110 configured to generate electric energy from solar power. This electric energy is used to power the electrolyzer 102, facilitating the electrolysis process that produces the oxygen 12 and the hydrogen 14 from the water 10. In particular, the PV cell unit 110 harnesses and converts solar energy into electrical energy (in the form of electric current), which is then supplied to the electrolyzer 102 for the electrolysis process. This solar-to-electrical energy conversion process provides a renewable and environment-friendly power source for the electrolyzer 102. Herein, the PV cell unit 110 may use any one of monocrystalline PV cells, polycrystalline PV cells, thin-film PV cells, concentrated PV cells, or the like, without any limitations. The choice may depend on factors such as the available budget, the amount of sunlight available, the desired efficiency, and the specific requirements of the system 100.

The system 100 further includes an absorption cooling unit (ACU) 112 having a cold air outlet 116. The ACU 112 is configured to expel cold air through the cold air outlet 116. In general, absorption cooling systems are thermally driven systems that use low-grade thermal energy for cooling production, making the exploitation of solar energy a promising sustainable solution. The working principle of the absorption chiller is based on a cycle of desorption and absorption phases of the used absorbent material. For purposes of the present disclosure, the ACU 112 may be of any suitable type, such as, but not limited to, single-effect absorption cooling units, multi-effect absorption cooling units, direct-fired absorption cooling units and indirect-fired absorption cooling units. The ACU 112 may, generally, include a condenser, evaporator, refrigerants, and an absorber. The specific type of the ACU 112 used in the system 100 may depend on various factors such as desired temperature of the air required, properties of heat transfer medium, and the operational conditions of the system 100.

The ACU 112 includes a solar parabolic trough collector (PTC) 118. The PTC 118 is a type of solar collector that uses a field of mirrors to concentrate thermal energy of sunlight onto a heat collector element present at the focal line of the PTC 118. Herein, the PTC 118 utilizes a heat transfer medium (as represented by reference numeral 30 in FIG. 1), which could be air, water, oil, molten salts, or other suitable material, to absorb the thermal energy, and subsequently transfer the absorbed thermal energy to where it is needed. In the system 100, the PTC 118 is configured to transfer the thermal energy, via the heat transfer medium 30, to the ACU 112, which then cool the ambient air into the cold air. It may be appreciated that the PTC 118 generates a significant amount of heat, and may operate at high temperatures, which can improve the efficiencies of processes in the system 100 and specifically of the ACU 112.

In an exemplary embodiment, as illustrated in FIG. 1, the PTC 118 is in radiative connection with a plurality of reflectors that are configured to reflect sunlight (as represented by reference numeral 32) onto the PTC 118. The PTC 118 harnesses solar thermal energy from the sunlight 32, which may be in the form of solar radiation, reflected by the plurality of reflectors and uses it to heat the heat transfer medium 30. In an example, the plurality of reflectors may be in the form of heliostats, in which each heliostat is motorized and computer-controlled to track the sun as it moves across the sky, keeping the reflected sunlight 32 focused throughout the day. This concentrated sunlight 32 may generate intense heat, which in the case of the PTC 118 is used to heat up the heat transfer medium 30.

The system 100 further includes a cryogenic air separation unit (CSU) 120. The CSU 120 has a compressed air inlet 122, an oxygen outlet 124, and a nitrogen outlet 126. In the present configuration, the CSU 120 incorporates cryogenic distillation, that separates oxygen from the air by liquefying the air at very low temperatures (−300° F.). The air is compressed in multiple stages with inter-stage cooling then further cooled with chilled water. The CSU 120 separates the air into oxygen (as represented by reference numeral 40) and nitrogen (as represented by reference numeral 42). The separated oxygen 40 is then expelled from the CSU 120 through the oxygen outlet 124 (to be stored in an oxygen tank or the like), while the separated nitrogen 42 is expelled through the nitrogen outlet 126.

Further, as illustrated, the system 100 includes a cooler 128 thermally coupled with the ACU 112 and at the compressed air inlet 122 of the CSU 120. The PTC 118 is configured to provide thermal energy for the ACU 112 and the cooler 128. The system 100 further includes an air turbine 134, an air compressor 136, a hydrogen compressor 138, and a nitrogen compressor 140. The air compressor 136 has an air inlet 142 and an air outlet 144. The air outlet 144 of the air compressor 136 is fluidly connected to the air turbine 134 upstream of the cooler 128. The high-pressure air is expanded in the air turbine 134 which is pneumatically connected to the air compressor 136. This expanded air is then transferred to the CSU 120 via the cooler 128. Herein, ambient air (as represented by reference numeral 20) is, essentially, first drawn into the air compressor 136 through the ambient air inlet 142. In the present system 100, the air compressor 136 is driven by a motor 135, which may draw power for its operation using the electrical energy generated by the PV cell unit 110. In particular, the motor 135 is connected to the air compressor 136 and the air turbine 134, and electrically connected to the PV cell unit 110. The air compressor 136 compresses the ambient air 20, which is subsequently expelled through the high-pressure air outlet 144. This high-pressure air 20 is then directed to the cooler 128. In the system 100, the nitrogen 42 from the CSU 120, which carries some heat from the air separation process, enters the nitrogen compressor 140 via a nitrogen compressor inlet 130. In particular, the nitrogen compressor 140 is fluidly connected to the nitrogen outlet 126 of the CSU 120. In the nitrogen compressor 140, the nitrogen 42 is compressed and the density of the nitrogen 42 is increased for the subsequent generation of ammonia. Also, the nitrogen compressor 140 has a nitrogen compressor outlet 145. The nitrogen 42 gets compressed in the nitrogen compressor 140, and the compressed nitrogen 42 is expelled via the nitrogen compressor outlet 145 therein. Further as illustrated, the hydrogen compressor 138 has a hydrogen inlet 146 and a hydrogen outlet 148. The hydrogen inlet 146 of the hydrogen compressor 138 is in fluid communication with the hydrogen outlet 108 of the electrolyzer 102 to receive the hydrogen 14 therefrom. The hydrogen 14 gets compressed in the hydrogen compressor 138, and the compressed hydrogen 14 is expelled via the hydrogen outlet 148 therein.

The system 100 also includes a catalytic converter 150. The catalytic converter 150 is equipped with a hydrogen inlet 152, a nitrogen inlet 154, and an ammonia outlet 156. The hydrogen outlet 148 of the hydrogen compressor 138 is in fluid communication with the hydrogen inlet 152 of the catalytic converter 150. Thereby, the compressed hydrogen 14 from the hydrogen compressor 138 is directed to the catalytic converter 150. Also, the nitrogen inlet 154 of the catalytic converter 150 is disposed in fluid communication with the nitrogen compressor outlet 145 of the nitrogen compressor 140. In particular, the hydrogen inlet 152 of the catalytic converter 150 is fluidly connected to the hydrogen outlet 108 of the electrolyzer 102 and the nitrogen inlet 154 of the catalytic converter 150 is fluidly connected to the nitrogen outlet 126 of the CSU 120. Herein, the compressed nitrogen 42 from the nitrogen compressor 140 enters the catalytic converter 150 through the nitrogen inlet 154, and the compressed hydrogen 14 from the hydrogen compressor 138 enters through the hydrogen inlet 152. The catalytic converter 150 is configured to catalyze reaction of the hydrogen 14 and the nitrogen 42 to form ammonia (as represented by reference numeral 60). The resulting ammonia 60 is then expelled from the catalytic converter 150 through the ammonia outlet 156.

It may be understood that the catalytic converter 150 is responsible for facilitating the chemical reaction between the hydrogen 14 and the nitrogen 42 to form the ammonia 60 in the system 100, via a conversion process often referred to as the Haber-Bosch process. The catalytic converter 150 typically consists of a reaction chamber containing a catalyst that accelerates the combination of the hydrogen 14 and the nitrogen 42 to form the ammonia 60. The catalyst is often made from metals like iron, ruthenium, or osmium, sometimes with additives to enhance its activity. The catalytic converter 150 includes a ruthenium-calcium-aluminum metal catalyst dispersed in hexagonal vacancies of a synthetic cordierite ceramic support. In an exemplary embodiment, the catalytic converter 150 is configured to catalyze the reaction of hydrogen and nitrogen to form the ammonia 60 at a pressure ranging from 200 bar to 500 bar. In an example, the ammonia 60 may be formed at a pressure ranging from 200 bar, 300 bar, 400 bar to 300 bar, 400 bar, and 500 bar. The high pressure within the catalytic converter 150 enhances the efficiency of the reaction, resulting in a higher yield of the ammonia 60.

During operation of the system 100, first, the PV cell unit 110 converts the solar energy into electrical energy, which is then supplied to the electrolyzer 102. The electrolyzer 102 facilitates the reaction that dissociates the water 10 into its elemental components, the oxygen 12 and the hydrogen 14. The hydrogen 14 is passed to the hydrogen compressor 138 for compression. In tandem, the air compressor 136 operates to draw in the ambient air 20, which is then compressed and delivered to the air turbine 134 and subsequently to the ACU 112. The ACU 112, thermally connected to the PTC 118, receives the heat transfer medium 30 heated by the PTC 118, and this thermal energy is used to cool the compressed air 20 within the ACU 112, resulting in the cold air 20 which is then directed to the CSU 120. The CSU 120 takes in the cold air 20 and separates the cold air 20 to form the oxygen 40 and the nitrogen 42 which is directed to the nitrogen compressor 140. The catalytic converter 150, receiving the compressed hydrogen 14 from the hydrogen compressor 138 and the compressed nitrogen from the nitrogen compressor 140, facilitates the Haber-Bosch process, producing the ammonia 60. It may be contemplated that, herein, the air compressor 136, the hydrogen compressor 138, and the nitrogen compressor 140 may be powered by the motor 135 initially (using electric energy from the PV cell unit 110), once the cycle is operational, the power may be drawn from the air turbine 134 to drive the hydrogen and nitrogen compressors 138, 140.

Thereby, the system 100 serves to produce the ammonia 60 and the oxygen 12, 40 using solar power. The system 100 achieves this by integrating a series of components that work in synergy, harnessing solar energy (including the reflected sunlight 32), facilitating the electrolysis of the water 10 to generate the oxygen 12 and the hydrogen 14, compressing and separating the air 20 into the oxygen 40 and the nitrogen 42, reacting the hydrogen 14 with the nitrogen 42 to form the ammonia 60, and efficiently utilizing byproduct heat from generation of the nitrogen 42 from various processes. The system 100 represents a significant advancement in renewable energy technology, providing a solution for the efficient, sustainable co-production of the ammonia 60 and the oxygen 12, 40. The ability of the system 100 to produce the ammonia 60 alongside the oxygen 12, 40 and surplus power (from the PV cell unit 110 and/or the PTC 118) may provide value in various industrial applications, including but not limited to, fertilizer production, fuel production, and various chemical processes.

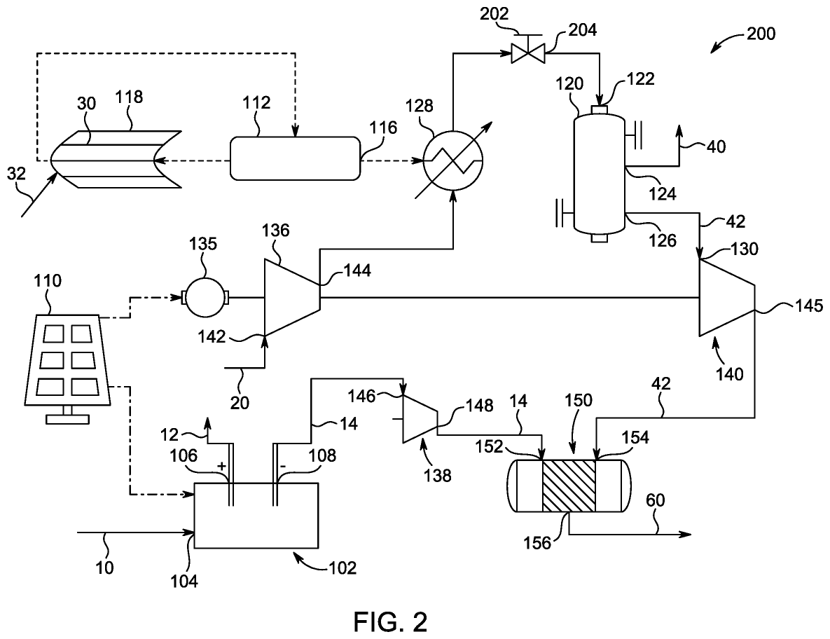

Referring to FIG. 2, illustrated is a schematic diagram of a solar-powered ammonia and oxygen production system 200 (hereinafter referred to as “the system 200”), according to some embodiments of the present disclosure. The system 200 includes a number of components similar to the solar-powered ammonia and oxygen production system 100 of FIG. 1 (as previously described), including the electrolyzer 102, the PV cell unit 110, the ACU 112, the PTC 118, the CSU 120, the cooler 128, the air compressor 136, the hydrogen compressor 138, the nitrogen compressor 140, and the catalytic converter 150. The details about these components are incorporated herein and is not repeated for brevity of the present disclosure. The system 200 further includes additional components for re-using heat generated from the production of gases, enhancing the overall efficiency thereof in comparison to the system 100.

As illustrated, the system 200 includes a throttle valve 202 having a low-pressure outlet 204 attached to the CSU 120. The throttle valve 202 is disposed in communication with the cooler 128. The key feature of the system 200 is expansion of the compressed air coming from the air compressor 136 through the throttle valve 202 instead of the expansion of the compressed air in the air turbine 134, as illustrated in the system 100. The throttle valve 202 further decreases the temperature of the compressed air before entering the CSU 120, by the virtue of rapid expansion of the compressed air, thereby increasing the overall efficiency of the system 200.

Therefore, the system 200 operates similarly to the system 100, but with the added feature of rapid expansion of the compressed air. By incorporating the throttle valve 202 into the system 200, the temperature of the inlet air into the CSU 120 is further decreased, that would otherwise not happen. This enhances the overall efficiency of the system 200 and contributes to its sustainability and makes the system 200 an efficient and eco-friendly solution for the co-production of ammonia and oxygen, as well as the generation of surplus energy.

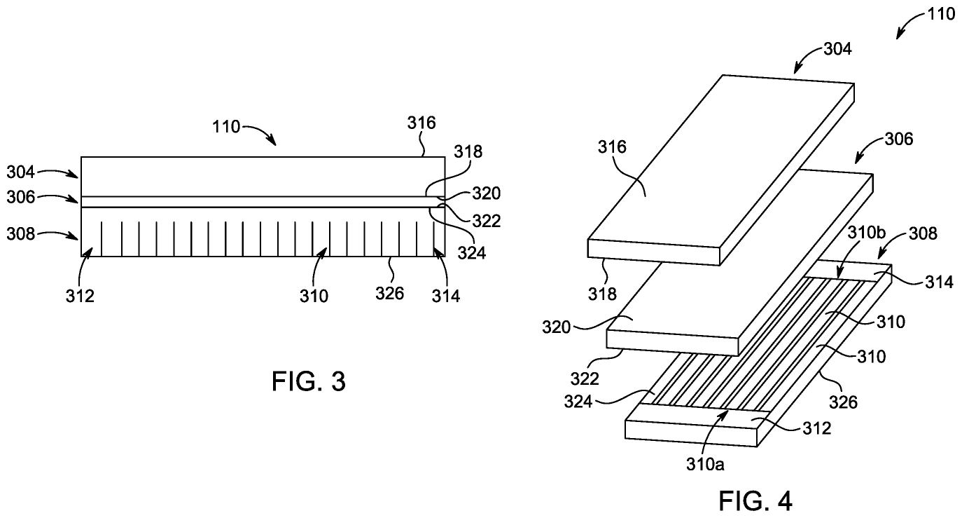

Referring to FIG. 3 and FIG. 4, a schematic side view and a schematic exploded view, respectively, of the PV cell unit 110 are illustrated, according to some embodiments of the present disclosure. The PV cell unit 110 is designed to convert solar energy into electrical energy, which is then used to power various components of the systems 100, 200. The PV cell unit 110 is structured as a layered assembly, with each layer serving a unique role in the functionality thereof. In particular, the PV cell unit 110 includes a PV panel 304, a thermoelectric generator panel 306, and a cooling plate 308. Herein, the PV panel 304 is the primary solar absorption layer, designed to capture and convert solar energy into electrical energy. The thermoelectric generator panel 306 is designed to harvest waste heat from the PV panel 304 and convert it into additional electrical energy. The cooling plate 308 is equipped with a plurality of water channels 310, which run longitudinally along a long axis of the PV panel 304, facilitating a flow of cooling water. These water channels 310 include an inlet header 312 at an upstream end 310a and an outlet header 314 at a downstream end 310b. The cooling plate 308 is configured to manage heat within the PV cell unit 110 and enhance its overall efficiency.

As illustrated, the PV panel 304 forms the topmost layer of the PV cell unit 110. The PV panel 304 has a front surface 316, which is exposed to the sunlight, and a back surface 318. Beneath the PV panel 304, and in direct thermal communication with its back surface 318, is the thermoelectric generator panel 306. The thermoelectric generator panel 306 has a front surface 320 in direct thermal contact with the back surface 318 of the PV panel 304, and a back surface 322. The bottommost layer of the PV cell unit 110 is the cooling plate 308. The cooling plate 308 has a front surface 324, which is in direct thermal contact with the back surface 322 of the thermoelectric generator panel 306, and a back surface 326.

In the PV cell unit 110, the PV panel 304 may be made up of several individual PV cells, each of which generates electricity when exposed to light. The generated electricity is then collected and directed to the electrolyzer 102, and optionally the electric motor(s) powering the compressors 136, 138, and 140, among other components. The thermoelectric generator panel 306 operates on the principle of the Seebeck effect, where a temperature differential across the front surface 320 and the back surface 322 creates a voltage difference, thereby generating additional electricity. This additional electricity may also be directed to various components of the systems 100, 200, augmenting the electricity produced by the PV panel 304. It may be appreciated that, herein, the thermoelectric generator panel 306 serves a dual function of generating additional electricity and cooling down the PV panel 304, thereby enhancing its efficiency. The cooling plate 308 aids in managing the heat produced by the PV panel 304 and the thermoelectric generator panel 306. The cooling plate 308 receives the water 10 (from some water source), via the inlet header 312, and this water 10 is circulated in water channels 310 to absorb the heat from the thermoelectric generator panel 306. This leads to a significant temperature gradient across the thermoelectric generator panel 306, enhancing its efficiency. The water 10, now heated, exits the water channels 310 via the outlet header 314.

It may be contemplated by a person skilled in the art that the layered design of the PV cell unit 110 enhances its thermal management capabilities. In an example embodiment, at least 90% of an area of the back surface 326 of the cooling plate 308 (and thus the PV cell unit 110) is in thermal communication with the water channels of the plurality of water channels 310. This significant coverage ensures an efficient heat exchange between the cooling plate 308 and the water 10 flowing through the water channels 310, aiding in effectively managing and utilizing the heat within the systems 100, 200. Also, at least 90% of the back surface 318 of the PV panel 304 is in direct thermal communication with the thermoelectric generator panel 306, or specifically the front surface 320 of the thermoelectric generator panel 306. This extensive contact area ensures maximum heat transfer from the PV panel 304 to the thermoelectric generator panel 306, thereby enhancing the thermal management of the PV panel 304 and increasing the heat available for conversion into electrical energy by the thermoelectric generator panel 306. Further, at least 90% of the back surface 322 of the thermoelectric generator panel 306 is in direct fluid communication (thermal contact) with the front surface 324 of the cooling plate 308, and thereby the water channels of the plurality of water channels 310. Consequently, the heat absorbed by the thermoelectric generator panel 306 from the PV panel 304 can be effectively transferred to the cooling plate 308. This arrangement further facilitates the heat exchange with the water flowing through the water channels 310, thus enhancing the overall efficiency of the systems 100, 200.

Further, as illustrated in FIG. 1 and FIG. 4, the outlet header 314 of the water channels 310 is in fluid communication with the water inlet 104 of the electrolyzer 102. The water 10 exits the water channels 310 via the outlet header 314 and is directed to the water inlet 104 of the electrolyzer 102. The water 10, which helped to cool down the PV cell unit 110 is pre-heated, enters the electrolyzer 102 and further improves the efficiency of the electrolysis process due to it being pre-heated. Thereby, this configuration not only provides a cooling mechanism for the PV cell unit 110 but also pre-heats the water 10 entering the electrolyzer 102, thereby enhancing the efficiency of the electrolysis process. As a result, this integrated PV cell unit 110 serves to augment the electrical energy production of the systems 100,200 and improve the efficiency of the electrolyzer 102.

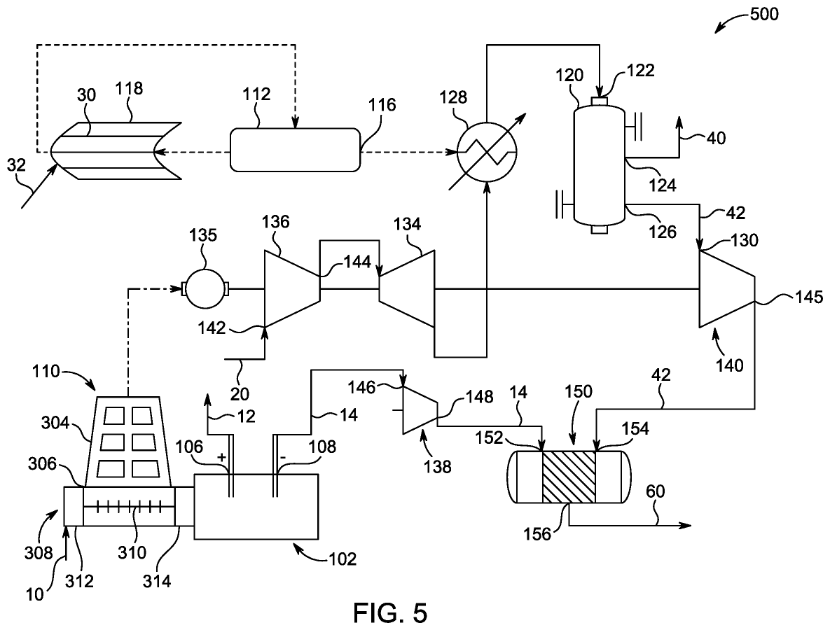

Referring to FIG. 5, illustrated is a schematic diagram of a solar-powered ammonia and oxygen production system 500 (hereinafter referred to as “the system 500”), according to an embodiment of the present disclosure. The system 500 shares similarities with the solar-powered ammonia and oxygen production system 100 of FIG. 1 (as previously described), including the electrolyzer 102, the PV cell unit 110, the ACU 112, the PTC 118, the CSU 120, the cooler 128, the air compressor 136, the hydrogen compressor 138, the nitrogen compressor 140, and the catalytic converter 150. Further, the PV cell unit 110 includes the PV panel 304, the thermoelectric generator panel 306, the cooling plate 308 and the plurality of water channels 310 therein. However, in the system 500, the thermoelectric generator panel 306 of the PV cell unit 110 is integrated with the electrolyzer 102, to further enhance the overall efficiency of the system 500 in comparison to the system 100.

In particular, in the system 500, the PV cell unit 110 is directly adjacent to the electrolyzer 102. The outlet header 314 of the plurality of water channels 310 is designed to be integral with the water inlet 104 of the electrolyzer 102. This unique positioning and integration allows for a direct and efficient heat transfer from the PV cell unit 110 to the electrolyzer 102. Specifically, the direct adjacency and integration of the PV cell unit 110 and the electrolyzer 102 facilitate an efficient heat transfer from the cooling plate 308 to the electrolyzer 102 through the integrated water channels 310 and the water inlet 104. Herein, the water 10 flowing through the water channels 310 can absorb the heat from the cooling plate 308 and carry it directly into the electrolyzer 102, thus effectively cooling down the PV cell unit 110 and at the same time providing the heat necessary for the electrolysis process within the electrolyzer 102. Moreover, the heat generated by the PV panel 304 and converted into electrical energy by the thermoelectric generator panel 306 can be used to power the electrolyzer 102. This arrangement further enhances the overall efficiency of the system 500 by enabling an efficient management of the heat and a more effective utilization of the generated heat therein.

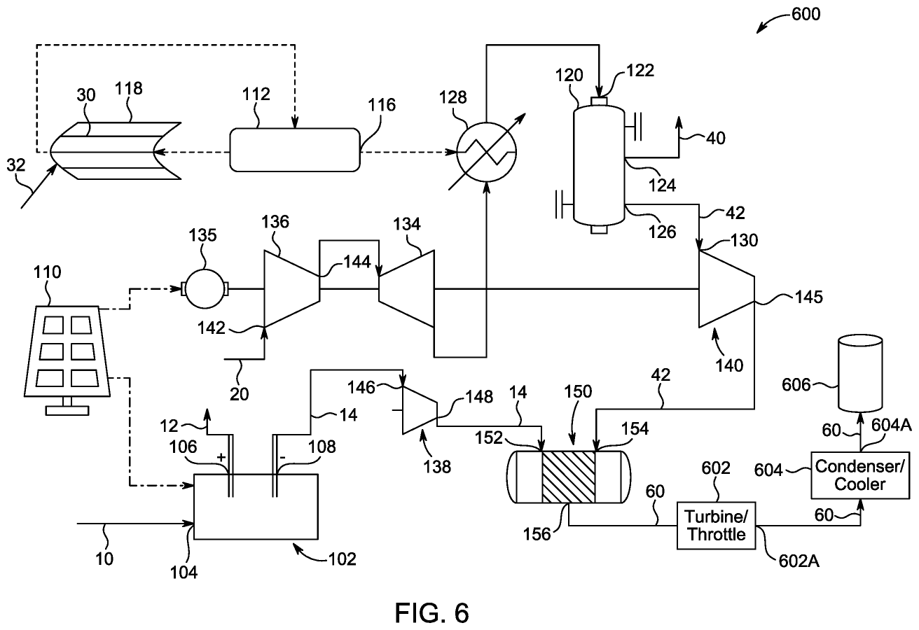

Referring to FIG. 6, illustrated is a schematic diagram of a solar-powered ammonia and oxygen production system 600 (hereinafter referred to as “the system 600”), according to an embodiment of the present disclosure. The system 600 shares similarities with the solar-powered ammonia and oxygen production system 100 of FIG. 1 (as previously described), including the electrolyzer 102, the PV cell unit 110, the ACU 112, the PTC 118, the CSU 120, the cooler 128, the air compressor 136, the hydrogen compressor 138, the nitrogen compressor 140, and the catalytic converter 150. However, in the system 600, there is an addition of an ammonia turbine/throttle 602. The ammonia turbine/throttle 602 is in fluid communication with the ammonia outlet 156 of the catalytic converter 150. The ammonia turbine/throttle 602 includes a low-pressure ammonia outlet (around 10 bar) 602a in fluid communication to a condenser 604. The condenser 604 liquifies the ammonia 60 and transfers the ammonia 60 to an ammonia storage tank 606 via an outlet 604a of the condenser 604, which is in fluid communication with the ammonia storage tank 606. The aforementioned components, that is, the ammonia turbine/throttle 602, the condenser 604 and the ammonia storage tank 606 improves the storage capacity of the system 600 by liquifying the ammonia 60. The ammonia turbine, preferably in combination with a throttle, functions to maintain a relatively constant ammonia flow at a suitable pressure. In some aspects the turbine may also function to compress or regulate the flow of ammonia, e.g., the turbine/throttle works in the absence of an ammonia compressor. Thereby, the efficiency of the system 600 is increased further.

Therefore, the solar-powered ammonia and oxygen production systems 100, 200, 500 and 600 provide an integration of various components and processes to co-produce ammonia and oxygen while concurrently generating surplus power. By utilizing solar power, the systems 100, 200, 500, and 600 provide a sustainable and renewable source of energy, which drastically reduces the reliance on fossil fuels for energy generation. The synergistic integration of various components optimizes performance and minimizes energy wastage in the systems 100, 200, 500, and 600. Thus, the present disclosure is pivotal in combating climate change by significantly lowering the carbon footprint associated with the production of ammonia and oxygen, two gases with extensive applications in various industries.

Numerous modifications and variations of the present disclosure are possible in light of the above teachings. It is therefore to be understood that within the scope of the appended claims, the present invention may be practiced otherwise than as specifically described herein.

1. A solar-powered ammonia and oxygen production system, comprising:
an electrolyzer having a water inlet, an oxygen outlet and a hydrogen outlet;
a PV cell unit comprising a PV panel, a thermoelectric generator panel, and a plurality of water channels, wherein the PV cell unit is electrically connected to the electrolyzer;
an absorption cooling unit (ACU) comprising a solar parabolic trough collector (PTC);
a cooler thermally connected to the ACU;
a cryogenic air separation unit (CSU) having a compressed air inlet, an oxygen outlet and a nitrogen outlet;
a nitrogen compressor fluidly connected to the nitrogen outlet of the CSU;
a catalytic converter having a hydrogen inlet, a nitrogen inlet and an ammonia outlet, wherein the hydrogen inlet of the catalytic converter is fluidly connected to the hydrogen outlet of the electrolyzer, and the nitrogen inlet of the catalytic converter is fluidly connected to the nitrogen outlet of the CSU; and
wherein the hydrogen outlet of the electrolyzer is fluidly connected to a hydrogen compressor fluidly connected to the hydrogen inlet of the catalytic converter;
a motor connected to an air compressor and an air turbine, wherein the motor is electrically connected to the PV cell unit and the air compressor has an air outlet fluidly connected to the air turbine upstream of the cooler.

2. The system of claim 1, wherein the electrolyzer comprises a solid polymer to catalyze dissociation of water to oxygen and hydrogen.

3. The system of claim 1, wherein the PTC is configured to provide thermal energy for the ACU and the cooler.

4. The system of claim 1, wherein the catalytic converter is configured to catalyze reaction of hydrogen and nitrogen to form ammonia at a pressure ranging from 200 bar to 500 bar.

5. The system of claim 1, wherein the catalytic converter comprises a ruthenium-calcium-aluminum metal catalyst dispersed in hexagonal vacancies of a synthetic cordierite ceramic support.

6. The system of claim 1, wherein each water channel of the plurality of water channels runs longitudinally along a long axis of the PV panel, wherein an upstream end of the water channels includes an inlet header, and a downstream end of the water channels includes an outlet header.

7. The system of claim 6, wherein the outlet header of the plurality of water channels is in fluid communication with the water inlet of the electrolyzer.

8. The system of claim 7, wherein at least 90% of an area of a back surface of the PV cell unit is in thermal communication with the water channels of the plurality of water channels.

9. The system of claim 8, wherein at least 90% of a back surface of the PV panel is in direct thermal communication with the thermoelectric generator panel.

10. The system of claim 9, wherein at least 90% of a back surface of the thermoelectric generator panel is in direct fluid communication with the water channels of the plurality of water channels.

11. The system of claim 10, wherein the PV cell unit is directly adjacent to the electrolyzer and the outlet header of the plurality of water channels is integral with the water inlet of the electrolyzer.

12. The system of claim 1, further comprising:
an ammonia turbine/throttle in fluid communication with the ammonia outlet of the catalytic converter.

13. The system of claim 12, wherein a low-pressure ammonia outlet of the ammonia turbine/throttle is in fluid communication with a condenser having an outlet in fluid communication with an ammonia storage tank.

14. The system of claim 1, wherein a hydrogen inlet of the hydrogen compressor is in fluid communication with the hydrogen outlet of the electrolyzer and a hydrogen outlet of the hydrogen compressor is in fluid communication with the hydrogen inlet of the catalytic converter.
